(19) United States
(12) Patent Application Publication
(10) Pub. No.: US 2012/0084729 A1
(43) Pub. Date: Apr. 5, 2012

(54) PROACTIVE BROWSING METHOD WITH SWING GESTURE IN FREE SPACE

(76) Inventor: Poshen Lin, Taipei (TW)

(21) Appl. No.: 13/234,157

(22) Filed: Sep. 16, 2011

(30) Foreign Application Priority Data
Oct. 1, 2010 (TW) 099133618

(51) Int. Cl. G06F 3/048

(52) U.S. Cl. 715/823; 715/830

(57) ABSTRACT

The method provides a browsing environment for a user in a free space through proactive interface design and dragging-style operation gesture. The method contains the following steps. First, an interface is provided, which contains a number of selection items. Then, an automatic selection zone is provided in the interface. Then, by pressing down a button of a remote control device and moving the remote control device, the selection items are scrolled. Then, as a selection item enters the automatic selection zone, the selection item becomes the automatic selected item, and clicking the selection item would execute the selection item. With this method, a remote control device with a single key could be conveniently used for browsing menu, setting configuration, and Internet navigation without looking at the remote control device.

### (a) TECHNICAL FIELD OF THE INVENTION

This invention is generally related to a proactive browsing method, and more particularly to a method, under the limitation of a single message channel, providing a browsing environment for a user through proactive interface design and dragging-style operation gesture in a free space.

### (b) DESCRIPTION OF THE PRIOR ART

In the digital era, digital and network technologies are integrated into conventional home appliances to become the so-called information appliances. Information appliances are consumer devices with built-in information functions. Their greatest features include simple operation, high reliability, easy maintenance, convenient installation, and fast learning. People of different ages or different education levels, including children or elder people, all need the various convenient services from the Internet, usually through the simple keypad of a remote controller. The simplicity of operation is the key requirement for all information appliances.

A conventional remote controller has quite a few keys, and is therefore difficult for an ordinary user to learn and operate. On the other hand, the computer mice require a flat surface to control the cursor, in addition to vision and fine movement control.

Further more, an ordinary remote controller or mouse requires multiple message channels so as to cooperatively achieve complex functions such as browsing and execution. Taking the remote controller as example, there is a keypad consisting of multiple buttons such as those for directional control, for turning on/off power, for playing/recording, etc. When a button is pressed, a specific electronic signal is transmitted from the remote controller to the information appliance through infrared transmitter/receiver.

As more functions are integrated into the information appliance, the remote controller requires more keys. A user has to look at the remote controller to choose the right key or key combinations. In addition, a user might have to remember the operation mode since some keys might provide multi-functions for multiple modes. As regards to the mouse, even though it is popular for computers, it also requires delicate control and visual aid, and cannot achieve its functions such as clicking and dragging with a single message channel. All these conventional means can hardly be operated with eye closed or in a poorly lit environment.

Therefore, a simple means which allows complex menu selection, command execution, configuration setting, and Internet navigation, but involves only simple swing gestures without looking at the remote control device is preferable.

### SUMMARY OF THE INVENTION

A major objective of the present invention is to provide a browsing method, under the limitation of a single message channel, provides a browsing environment for a user in a free space through proactive interface design and dragging-style operation of swing gesture.

Another objective of the present invention is to provide a browsing method, which is based on a finite-state machine to perform various actions such as opening/closing menu, pressing, dragging, releasing, etc.

Yet another objective of the present invention is to provide a browsing method which is based on the concept of automatic selection. With the method, the selection items are scrolled only in the horizontal or vertical direction so that users are refrained from delicate movement and visual burden. The selection items are automatically scrolled in a selection zone and selected with the aid of the interface. The scroll of the selection items is based on the relative displacement of a remote control device, instead of using absolute positions. As such, the user could freely choose a starting location and is not limited to some fixed locations. The method is applicable to any linear or tree-like menu structure, and the method could be used to conduct configuration setting. In addition, the method could provide visual, audio, or both modes of feedback.

To achieve these objectives, the method contains the following steps. First, an interface is provided, which contains a number of selection items. Then, an automatic selection zone is provided in the interface. Then, by pressing down a button of a remote control device and moving the remote control device, the selection items are scrolled. Then, as a selection item enters the automatic selection zone by swing gesture, the selection item becomes the automatically selected item, and further clicking that item would have it executed.

In an embodiment, the automatic selection zone is marked by borders or other visually differentiable means.

In an embodiment, when a button is pressed while a remote control device is moved, the selection items are scrolled in an animated manner in accordance with a relative displacement of the remote control device as visual feedback.

In an embodiment, when a button is pressed while a remote control device is moved, the selection items are scrolled horizontally or vertically in an animated manner in accordance with a relative horizontal or vertical displacement of the remote control device.

In an embodiment, when the relative displacement does not exceed a threshold, the visual feedback of item scrolling is not produced.

In an embodiment, when the horizontal relative displacement is greater than the vertical relative displacement, the selection items are scrolled horizontally as visual feedback.

In an embodiment, when the vertical relative displacement is greater than the horizontal relative displacement, the selection items are scrolled vertically as visual feedback.

In an embodiment, when the automatically selected item is a command item, the command will be executed by clicking it.

In an embodiment, the interface contains tree-structured menus and there are a parent menu and a child menu. The parent menu contains a number of parent selection items and the child menu contains a number of child selection items. When the automatically selected item is a menu item, a child menu associated with the menu item will be expanded by clicking on the item.

In an embodiment, when the selection items are scrolled downward and, when the button is release, the parent menu touches the automatic selection zone, a parent menu item automatically enters the automatic selection zone so as to return to a corresponding, one-level-above parent selection item.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow diagram showing the steps of a proactive browsing method according to a first embodiment of the present invention.

FIG. 2 is a schematic diagram showing an electronic system under the control of the proactive browsing method of FIG. 1.

FIG. 3 is a flow diagram showing the steps of a proactive browsing method according to a second embodiment of the present invention.

FIG. 4 is a schematic diagram showing an electronic system under the control of the proactive browsing method of FIG. 3.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention, under the limitation of a single message channel, provides a browsing environment for a user in a free space through proactive interface design and dragging-style operation gesture. In the future, a TV, projector, or media center could perform browsing, command execution, configuration, and even Internet navigation by a portable controller of the size of a pen or a button. With the present invention, the traditional remote controller would become more humanized and, given time, can be replaced by the new technology.

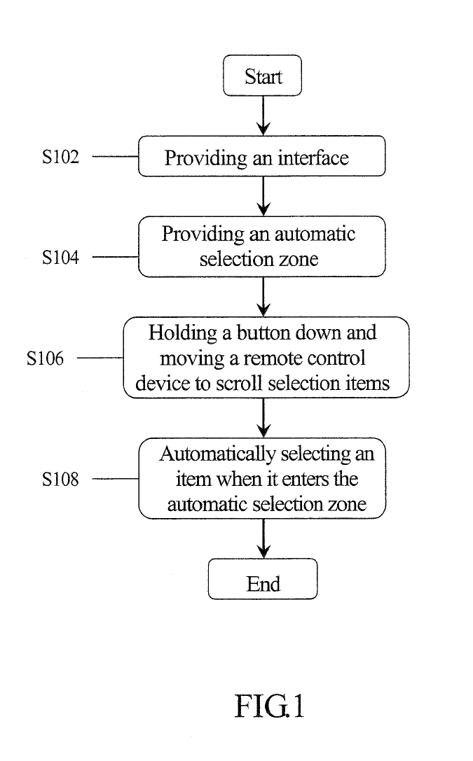

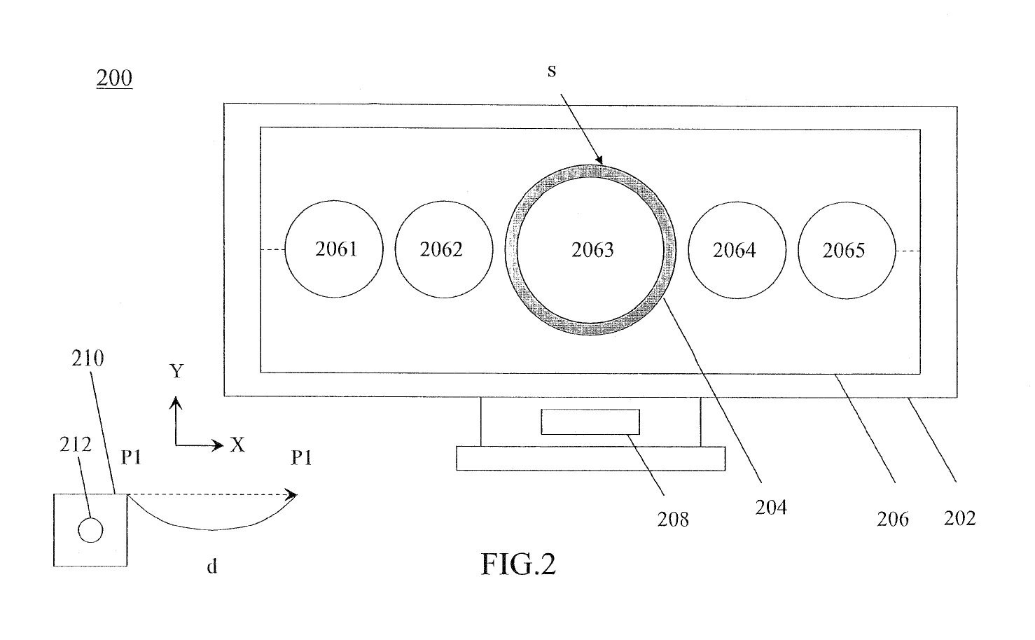

FIG. 1 is a flow diagram showing the steps of a proactive browsing method according to a first embodiment of the present invention. FIG. 2 is a schematic diagram showing an electronic system under the control of the proactive browsing method of FIG. 1. As illustrated, the active browsing method of the present invention is applied to an electronic system 200, which contains an electronic device 202, an interface 206, a signal reception device 208, and a remote control device 210.

The electronic device 202 could be a computer, a TV, a DVD player, a multimedia player, an information appliance, etc. For the DVD player, it could play the content stored in a DVD disk. For the TV, it could play the digital or analogue broadcast received its tuner. The DVD player could recognize a number of command sets, each corresponding to a specific function such as forwarding, time shifting, configuration, etc. For the forwarding command set, it could contain a number of commands such as fast forward, slow forward, fast forward at double speed, etc.

For the multimedia player, it could further contain peripheral input for receiving the control signal triggered by the user (such as a button pressed).

In the present embodiment, the active browsing method provides a free dragging mode by swing gesture. As illustrated in FIGS. 1 and 2, first, in step S102, an interface 206 is provided in the electronic device 202. The interface 206 contains a number of selectable items 2061, 2062, 2063, 2064, and 2065. Then, in step S104, an automatic selection zone 204 is provided in the interface 206. When one of the selection items 2061, 2062, 2063, 2064, and 2065 is in the automatic selection zone 204, the selection item is automatically selected.

In step S106, by pressing and holding a button 212 on the remote control device 210, a signal is continuously transmitted from the remote control device 210 and the signal is continuously received by the signal reception device 208 of the electronic device 202. The electronic device 202 calculates the relative displacement d of the remote control device 210 since the button 212 is released. The electronic device 202 then drags the automatic selection zone 204 in accordance with the displacement d.

In step S108, as the automatic selection zone 204 is dragged, the selection items 2061, 2062, 2063, 2064, and 2065 scroll in the interface 206. As, for example, the selection item 2063 is in the automatic selection zone 204, the selection item 2063 is automatically selected as the selected item S, as shown in FIG. 2. The selected item S is emphasized by a border or other visual means for differentiation.

In the present embodiment, when the button 212 is released and the selection items are scrolled, the displacement d is determined by a start location P1 and an end location P2 of the remote control device 210. The selection items are then scrolled horizontally in an animated manner for a distance corresponding to the displacement d (i.e., P2-P1) as a visual feedback.

In an alternative embodiment, the selection items 2061-2065 could be arranged in a two-dimensional array and the selection items could be scrolled both horizontally and vertically. For example, during when the button 212 is released, the remote control device 210 is moved from a start location P1 for a displacement d to an end location P2. The displacement d involves a horizontal component |dx| and a vertical component |dy|. The selection items are then scrolled horizontally and vertically in an animated manner corresponding to the horizontal and vertical displacements |dx| and |dy|, respectively, as a visual feedback.

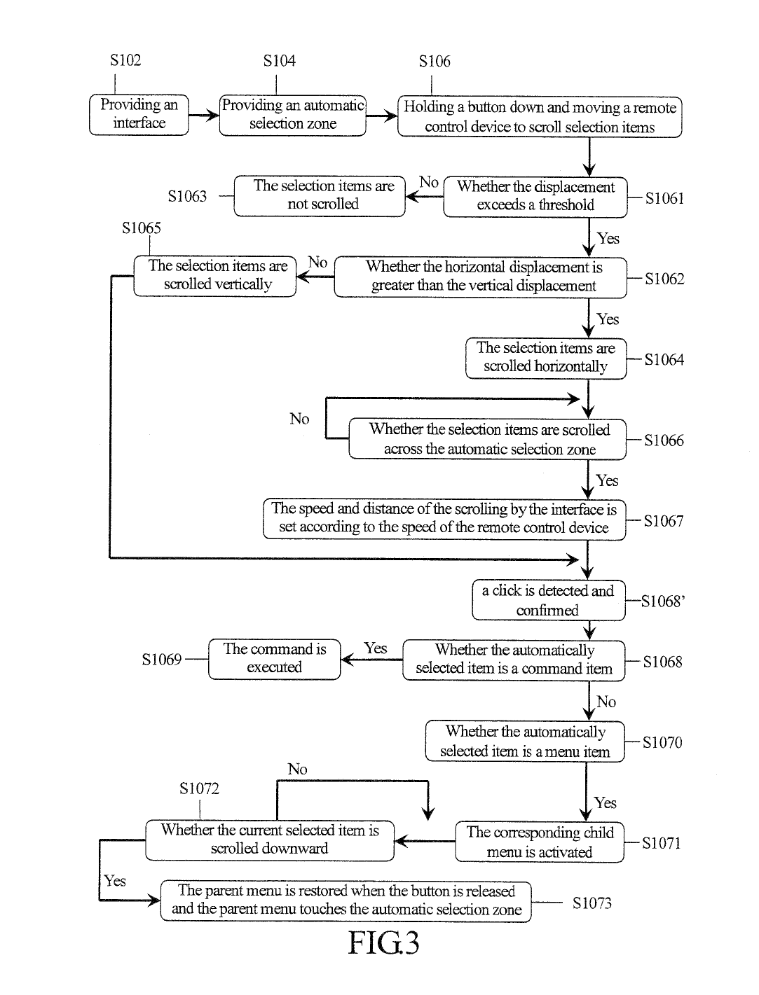

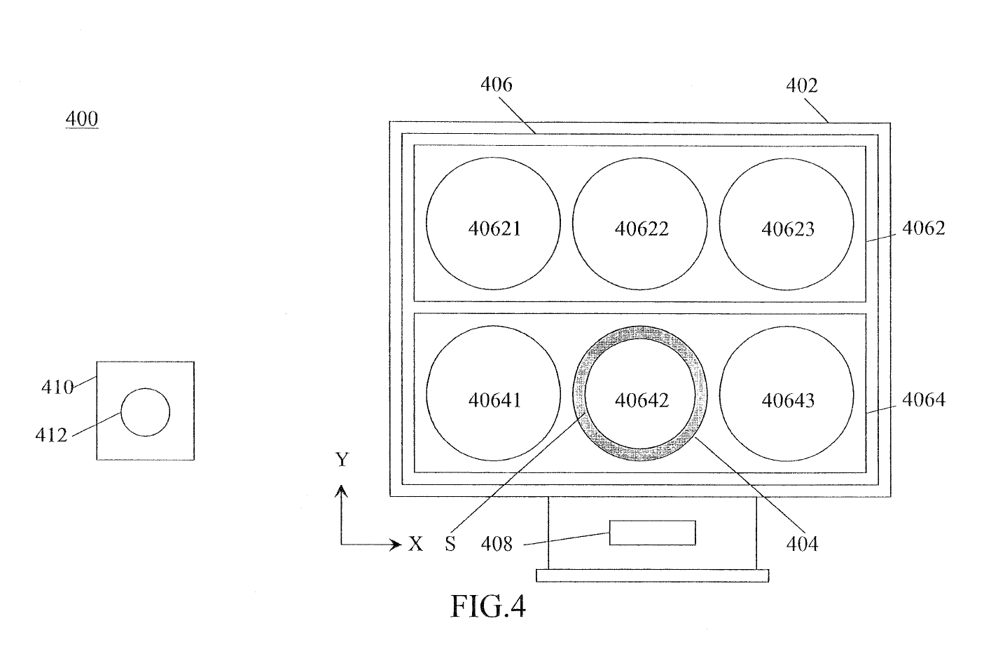

FIG. 3 is a flow diagram showing the steps of a proactive browsing method according to a second embodiment of the present invention. FIG. 4 is a schematic diagram showing an electronic system under the control of the active browsing method of FIG. 3. As illustrated, in addition to the steps shown in FIG. 1, FIG. 3 further contains the following steps. In step S1061, to avoid misjudgment from slight movement of the remote control device 410, the displacement d is determined to see if it exceeds a threshold. If not, the selection items are not scrolled in step S1063. If yes, whether the horizontal displacement |dx| is greater than the vertical displacement |dy| is determined in step S1062.

If the horizontal displacement |dx| is greater than the vertical displacement |dy|, in step S1064, the selection items (i.e., the parent items 40261, 40262, and 40263, and the child items 40641, 40642, and 40643) are scrolled horizontally in accordance with the horizontal displacement |dx| in an animated manner as a visual feedback. As the selection items are scrolled, the electronic device 402 would prompt the name of the item entering the automatic selection zone 404.

On the other hand, if the horizontal displacement |dx| is less than the vertical displacement |dy|, in step S1065, the selection items (i.e., the parent items 40261, 40262, and 40263, and the child items 40641, 40642, and 40643) are scrolled vertically in accordance with the vertical displacement |dy| in an animated manner as a visual feedback.

In step S1066, whether the selection items are scrolled across the automatic selection zone 404 is determined. If yes, in step S1067, the speed and distance of the scrolling by the interface 406 is set in accordance with the speed of the remote control device 410. When multiple selection items are scrolled, the electronic device 402 uses tones of increasing or decreasing pitches to indicate the degree of scrolling. In addition, when the interface 406 has scrolled to the rightmost or leftmost selection item, the electronic device 402 produces a special audio effect to indicate that the selection items could not be scrolled further, and then announces the selection item entering the automatic selection zone 404.

In step S1068, a click is detected and whether the automatically selected item (e.g., in FIG. 4, it is the child item 40642) is a command item is determined. If yes, the command is executed in step S1069.

The interface 406 contains a parent menu 4062 and a child menu 4064. The parent menu 4062 contains a number of parent selection items 40621, 40622, and 40623. The child menu 4064 contains a number of child selection items 40641, 40642, and 40643. The child menu 4064 is an auxiliary menu to the parent menu 4062. When the automatically selected item S is a menu item, a child menu 4064 corresponding to the menu item S is activated.

Therefore, in step S1070, whether the automatically selected item in the automatic selection zone 404 is a menu item is determined. If yes, in step S1071, the corresponding child menu 4064 is activated. For example, as illustrated in FIG. 4, if the automatically selected item 40622 is a menu item, the child menu corresponding to item 40622 is then activated.

In step S1072, whether the current selected item (i.e., the child selection item 40642) is scrolled downward is determined. If yes and when the button 412 is released and the parent menu 4062 touches the automatic selection zone 404, the parent menu 4062 is restored in step S1073. For example, when the child selection item 40642 is scrolled downward, the automatic selection zone 404 returns to the parent selection item 40622. In the mean time, the electronic device 402 would announce the item name entering the automatic selection zone 404.

With the present invention, the remote control device could be simplified to having a single key and could be operated by touching without looking at the remote control device. With the automatic selection of a proactive interface and animation, tree-structured menu or process could be easily browsed. Under the limitation of a single message channel, the present invention provides a browsing environment for a user in a free space through proactive interface design and dragging-style operation gesture. First of all, a finite-state machine model is adopted to perform various actions such as opening/closing menu, pressing, dragging, releasing, etc. Then, the concept of automatic selection is adopted for interface design. With the method, the selection items are scrolled only in the horizontal or vertical direction so that users are refrained from delicate movement and visual burden. The selection items are automatically scrolled in a selection zone and selected with the aid of the interface.

The scroll of the selection items is based on the relative displacement of a remote control device, instead of using absolute positions. As such, the user could freely choose a starting location and is not limited to some fixed locations. The method is applicable to any linear or tree-like menu structure, and the method could be used to conduct configuration setting. In addition, the method could provide visual, audio, or both modes of feedback.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A proactive browsing method, comprising the following steps:
providing an interface having a plurality of selection items;
providing an automatic selection zone in said interface;
scrolling said selection items by pressing and holding a button of a remote control device and moving said remote control device; and
automatically selecting a selection item when said selection item enters said automatic selection zone and executing said selection item when said selection item is clicked.

2. The proactive browsing method according to claim 1, wherein said automatic selection is marked by borders or other visually differentiable means.

3. The proactive browsing method according to claim 1, wherein said selection items are scrolled in an animated manner as visual feedback in accordance with a relative displacement of said remote control device.

4. The proactive browsing method according to claim 3, wherein said selection items are scrolled horizontally or vertically in an animated manner as visual feedback in accordance with a horizontal or vertical relative displacement of said remote control device.

5. The proactive browsing method according to claim 3, wherein said visual feedback of scrolling selection items is not produced if said relative displacement does not exceed a threshold.

6. The proactive browsing method according to claim 5, wherein, when said horizontal relative displacement is greater than said vertical relative displacement, said selection items are scrolled horizontally in accordance with said horizontal relative displacement.

7. The proactive browsing method according to claim 5, wherein, when said vertical relative displacement is greater than said horizontal relative displacement, said selection items are scrolled vertically in accordance with said vertical relative displacement.

8. The proactive browsing method according to claim 1, wherein, if said automatically selected item is a command item, said command item is executed.

9. The proactive browsing method according to claim 1, wherein said interface contains tree-structured parent menu and child menu; said parent menu contains a plurality of parent selection items; said child menu contains a plurality of child selection items; said child menu is associated with said parent menu; and, when said automatically selected item is a menu item, a child menu corresponding to said selected menu item is activated.

10. The proactive browsing method according to claim 9, wherein, when said selection items are scrolled downward and, when said button is released, said parent menu touches said automatic selection zone, said parent menu is restored.
